(19) United States
(12) Patent Application Publication
(10) Pub. No.: US 2015/0337949 A1
(43) Pub. Date: Nov. 26, 2015

(54) DEVICE WITH ELEMENTS WHICH CAN BE MOVED RELATIVE TO ONE ANOTHER, PREFERABLY A PLANETARY DRIVE

(71) Applicant: Schaeffler Technologies Gmbh & Co. KG, Herzogenaurach (DE)

(72) Inventors: Andreas Ziegler, Charlotte, NC (US); Juergen Windrich, Leimen (DE); Alexander Pabst, Erlangen (DE)

(21) Appl. No.: 14/411,033

(22) PCT Filed: May 13, 2013
(86) PCT No.: PCT/EP2013/059816

§ 371 Date: Dec. 23, 2014

(30) Foreign Application Priority Data
Jun. 25, 2012 (DE) 102012210689.8

(51) Int. Cl. F16H 57/08; C10M 107/38; C22C 19/03; F16H 1/36; F16H 57/04

(52) U.S. Cl. CPC F16H 57/08; F16H 1/36; F16H 57/041; F16H 57/0482; F16H 57/0471; C22C 19/03; C10M 107/38; F16H 2057/085

(57) ABSTRACT

A device including elements arranged to move relative to each other, wherein the elements include at least one first element on a bearing point, a second element, wherein the bearing point is rotatably or pivotably mounted on the second element, a third element rotatable around a central axis, wherein the second element is mounted on the third element at a radial distance from the central axis, a fourth element that is integral to the bearing point and is temporarily in sliding contact with another element in a sliding contact zone, which sliding contact zone is arranged to have a surface section having a layer comprising, a nickel-phosphate alloy, and at least one solid lubricant distributed in the layer, wherein a ratio of the surface roughness of the rough metal surface to the layer thickness of the at least one layer is in the range of at least 0.0008 to 3.0.

### CROSS-REFERENCE TO RELATED APPLICATIONS

The present application is the U.S. national stage application pursuant to 35 U.S.C. §371 of International Application No. PCT/EP2013/059816, filed on May 13, 2013, which application claims priority from German Patent Application No. DE 102012210689.8, filed on Jun. 25, 2012, which applications are incorporated herein by reference in their entireties.

### TECHNICAL FIELD

The invention relates to a device with elements that can be moved relative to one another, for example, a planetary drive, of which elements at least one first element on at least one bearing point is rotatably or pivotably mounted on a second element, where the second element is mounted on a third element that is rotatable around a central axis of the device at a radial distance is to the central axis of the device, and where the bearing point has at least one fourth element which is at least temporarily in sliding contact with one of the elements in at least one sliding contact zone.

### BACKGROUND

In planetary drives, a planetary gear is rotatably mounted in each case by means of at least one roller bearing on a planetary bolt in the respective bearing point. The planetary bolts are fixed on a planet carrier at a radial distance to a central axis of the planetary drive. If the planet carrier rotates around the central axis, then the planetary bolts and the respective planetary gear with the roller bearing revolve around the central axis on an annular orbital track. The radius of the orbital track corresponds to the radial distance of the bolt axis of the planetary bolts to the central axis.

Slide bearings or roller bearings are provided as radial bearings and in most cases slide bearings are provided as thrust bearings in the bearing points of the planetary drives.

It is characteristic for arrangements of this type that the roller bearing is loaded not only by the usual bearing loads during the operation of the drive of the respective device, but is also exposed to the influence of centrifugal forces. The centrifugal forces arise from the mass of the element mounted on the bolt or pin, and potentially from further elements connected with the same, as well as from the mass of the elements of the roller bearing. The extent of these centrifugal forces is dependent on the radius of the orbital track and on the rotational speed of the planetary drive.

Planetary drives are widely known in the art. With regard to this invention, particular attention is directed to planetary drives in vehicle drives. The demands placed on the bearing points of the planetary drives are very high, due to the increasing rotational speeds to which the planetary drives of modern transmissions are exposed.

In the planetary drives of modern automatic transmissions, the radial distances of the planetary gears to the central axis are relatively large or the rotational speeds are high. The acceleration values resulting from these two influencing factors, to which the elements supported by means of the roller bearings and the elements of the roller bearing are exposed, can reach 5000 times the force of gravity. These high accelerations cause high forces in the bearing points, which are centrifugal forces resulting from the masses of the planetary gears and the rolling of the roller bearing. These forces can be summed using the bearing loads in the roller bearings arising from the usual power inputs.

In roller bearings, the roller bodies and the cages in which the roller bodies are guided are particularly highly loaded. The ladder-like structured cages are particularly highly stressed, since the lateral edges and cross bars thereof have relatively small cross sections, in comparison with the diameter and width of the primary dimensions, and therefore elastically deform under high loads and centrifugal forces. Slowly advancing fatigue, due to the constant flexural variations in stress, leads to material fatigue and finally to cracks, due to which the cage breaks down prematurely. Relatively sharp edges in the corners of the pockets are potential notches having the correspondingly disadvantageous notch effect during mechanical variations in stress. Therefore, designers of roller bearings constantly endeavor to optimize the cage geometry and seek further measures to improve the strength of the cages. It is known from German Patent Application No, DE 10 2010 009 391 A1 that the fatigue strength of the cages of planetary bearings can be improved by blasting with particles using “shot peening.” This type of preventive measure is, however, not always sufficient.

The roller bodies of planetary bearings are rollers. Rollers are, in outline, externally cylindrical elements, and the lateral surfaces and end sides of which can be concave or spherically convex. The rollers are also called needles in the context of planetary bearings. Needles are rollers that have a ratio of their axial length to the nominal diameter greater than or equal to the numeric value of 3. Cylinder and barrel rollers are rollers, in which this ratio is less than the numeric value of 3. The outline of the cages is a hollow cylinder and the structure thereof is open-work like a ladder with lateral edges extending in the peripheral direction, which edges are axially connected to one another by cross bars. The cross bars lie opposite the pockets of the cage in the peripheral direction. The rollers are received in the pockets.

During the rotation of the planetary gear, the respective roller bearing rotates along with it. The rollers sequentially pass through the bearing zone and carry thereby with them the bearing bodies rolling outside of the bearing zone by means of the cage. The rollers that are not passing through the load zone of the roller bearing remain, due to slippage and due to the inertia thereof, as opposed to those rollers that are passing through the load zone, and support themselves thereby in the peripheral direction in the pockets at the cross bars. The roller bodies in the load zone pull the cage, as a result thereof, and the other roller bodies via the cage until the other roller bodies enter into the load zone. The inertia, of the roller bodies and, additionally, the influence of the centrifugal forces described above stress the cross bars of the cage, on which the rollers support themselves, and the lateral edges of the cage, from which the cross bars branch off of like beams. Since the roller bodies pass sequentially through the load zone, the cage is constantly stressed, alternating between traction and compression during rotation, and thereby deforms. In addition, the cage also deforms in the direction of the centrifugal forces.

The contact between the roller bodies and the respective cage is a sliding contact in sliding contact zones on the surface sections of the roller bodies and cage that contact one another. In addition, the cages are deformed during high accelerations due to their own weight and the centrifugal forces resulting therefrom, which can also lead to sliding contact between the rollers and the cages.

The cages of a planetary drive are, presuming a sufficient pocket tolerance of the respective roller body in its pocket of the cage, pressed outward by centrifugal forces against the outer race or laterally against sections of the outer race during rotation of the planet carrier and stabilized there. If the roller bearings rotate simultaneously, then the respective cage moves around the planetary bolt relative to the planetary gear and is guided outward on the planetary gear, by which means surface sections of the cage wear down opposing surface sections of the planetary gear by sliding past one another in sliding contact zones.

In the ideal roller contact, the rotational axes of the rollers are oriented parallel to the rotational axis of the planetary bolt. Irregularities in the bearing point, such as deformations of the bolt or of the cage, centrifugal forces, and clearances, can lead to oblique positions of the rollers in such a way that the rotational axes thereof are no longer oriented parallel to the rotational axis of the bolt. The results are thrust forces in the axial direction, which lead to so-called. “screwing” of the rollers. In this case, the rollers run axially on the cage, which is pressed thereby axially against the surrounding area. In planetary drives, the surrounding area is formed by surface sections of planet carriers or generally by sliding disks. Rotation of the cages around the planetary bolts results in relative movements of the same opposite the planet carriers or sliding disks, such that facing end surface sections of the cages are in sliding contact with the surrounding area in sliding contact zones.

Sliding contact zones harbor potential for premature wear, as often not enough lubricant can be supplied into the sliding contact zones because the surface of the friction partners in the sliding contact zone is rough and/or because the lubricating film tears off. In addition, the frictional forces that arise thereby cause energy losses. A roller bearing is known from U.S. Pat. No. 5,482,385 A, the cage of which is provided with a coating at the surface sections for potential sliding contact with the rollers and the surrounding area. The wear protection and sliding layer is composed of nickel and phosphorus, and has components of the solid lubricant PTFE.

### SUMMARY

According to aspects illustrated herein, there is provided a device including a plurality of elements arranged to move relative to each other, wherein the plurality of elements includes at least one first element of the plurality of elements on an at least one bearing point, a second element, wherein the at least one bearing point is rotatably or pivotably mounted on the second element, a third element arranged to be rotatable around a central axis of the device, wherein the second element is mounted on the third element at a radial distance from the central axis of the device, a fourth element, wherein the fourth element is integral to the at least one bearing point and is at least temporarily in sliding contact with another of the plurality of elements in at least one sliding contact zone, which sliding contact zone is arranged to have at least one surface section having at least one layer including a nickel-phosphate alloy and at least one solid lubricant distributed in the at least one layer, wherein a ratio of a surface roughness of a rough metal surface of the at least one surface section to a thickness of the at least one layer of the at least one layer is in a range of at least 0.0008 to 3.0.

The object of the invention is to create a device, the elements of which that are in frictional contact have improved wear and sliding characteristics.

The invention relates in particular to a planetary drive with elements that can be moved relative to one another, of which elements at least one first element, designed as a planetary gear, on at least one bearing point is rotatably or pivotably mounted on a second element, designed as a planetary bolt, where the planetary bolt is mounted on a planet carrier that is rotatable around a central axis of the planetary drive at a radial distance to the central axis of the planetary drive, and where the bearing point has at least one fourth element designed as a cage, thrust washer, or planet carrier, which fourth element is at least temporarily in sliding contact with one of the elements in at least one sliding contact zone, where at least one surface section on at least one of the elements of the device in the sliding contact zone has at least one layer made of a nickel phosphorus alloy, where particles of at least one solid lubricant are distributed in the layer.

A ratio V of a surface roughness Rₐ of the rough metal surface of the surface section, for example, prior to coating with the layer, to a layer thickness S of the coating, measured perpendicular to the surface, has, after the coating of the surface section with the layer, values ranging from at least 0.0008 to 3.

$$0.0008 \leq V = \frac{{R}_{a}}{S} \leq 3$$

Table 1 shows the correlation of this ratio to different typical surface sections for sliding contact on one or more element(s) of the device that are in sliding contact.

TABLE 1

| Surface section on | vₘᵢₙ | Vₘₐₓ |
|---|---|---|
| Perimeter and | 0.025 | 0.5 |
| tangential surfaces | 0.01 | 2 |
| Axial surfaces | 0.0008 | 0.16 |
| | 0.003 | 0.6 |
| | 0.01 | 2 |
| | 0.016 | 3 |

The unevenness of the surface height of an element is described as roughness and is defined for example according to DIN 4760. The roughness of a textured surface is indicated using surface data such as Rₐ.

The average roughness Rₐ indicates the average distance in pm of a measured point on the surface to a midline M, as shown in FIG. 6, The midline M intersects, within a defined reference length B, at the contact surface on the zig-zag line Z, the actual roughness profile as shown in FIG. 6, such that the sum of the profile deviations relative to the midline is minimal. The actual roughness profile is characterized by the distances, perpendicular to the surface, between the deepest points in the roughness valleys and the highest points of the roughness peaks. The average roughness thus corresponds to the arithmetic mean of the deviations from the midline in the valleys and peaks and is thus the arithmetic average value of all profile values of the roughness profile.

A smooth, error-free surface of the metal material is a prerequisite for an error-free homogeneous coating. High roughnesses can lead to insoluble remnants from the pretreatment solvents; abrasive, polishing, or blasting means can remain in large roughness valleys, and “clog” them against a connecting layer. It is, however, disadvantageous that reductions in roughness values generally cause higher production costs.

An embodiment of the invention provides that the at least one element, which has a sliding coating with the inventive characteristics, is a cage. The cage is made of sheet metal and is cold formed from sheet metal strips or sheet metal tubes, out of which the pockets are punched out, and the mountings for the roller bodies are formed by reshaping.

Table 2 shows the roughnesses of the typical surface sections of a cage for sliding contact prior to the coating, which surface sections are formed on the outwardly facing surfaces (lateral surfaces), the lateral edges, and the cross bars at contact points between the cage and the rollers or at the end sides of the cage. The surfaces described with roughnesses arise from the processing steps or machining conditions listed in the table. Table 2 lists only examples of possible treatments. The listing should not be considered exhaustive. Thus, for example, the term blasting with granular material stands for all conceivable surface processes, in which granulate shaped blasting means in the form of balls or grains made of different possible materials are blasted at high speeds at the surface to be treated.

Additional elements or surface sections of the elements coated with the sliding layer are gears (planetary gears), planet carriers, and preferably the thrust washers, which are arranged axially between a cage of a roller bearing and the planet carrier and/or between a planetary gear and the planet carrier. It is also provided that both surface sections sliding on one another in the device are provided with the same coating or with coatings of differing compositions.

TABLE 2

| | | | Roughness | |
|---|---|---|---|---|
| Cage | Description of the surface | | R_{a max} | R_{a min} |
| Lateral surface | made of sheet | | 1 | 0.25 |
| Front face | metal, formed by | | 1.5 | 0.08 |
| | punching, bending, | | | |
| | welding, grinding, | | | |
| | brushing, blasting | | | |
| | with granular | | | |
| | material, heat | | | |
| | treatment | | | |
| Front face | | Grinding in | 0.3 | 0.08 |
| | | hardened state | | |
| | | Shot peening in | 1 | 0.3 |
| | | hardened state | | |

A thick layer on the surface usually assures the best wear characteristics. However, thicker layers can also react disadvantageously with respect to their strength characteristics. In addition, the production of thicker layers is usually linked to higher costs, since the deposition times are an important criterion during coating.

Deviating from the earlier, rather random selection of measures for improving the wear production and the sliding characteristics, the invention was made within the context of tests and calculations, using those calculations whose results led to the above cited ratio of roughnesses Rₐ and layer thickness S, and preferably have values in within the limits of:

$$0.005 \leq V = \frac{{R}_{a}}{S} \leq 1.2$$

Values of this type are, for example, associated with the surface sections of a cage or a thrust washer, each made of steel, which are hardened after shaping and/or punching, and are fixed using shot peening after hardening.

The advantageous effects of the invention are optimal relationships of performance characteristics of the surface and the production costs thereof.

An embodiment of the invention provides that the layer is formed of chemical nickel. The term “chemical nickel” stands for a currentless (autocatalytic-chemically reductive process at temperatures between 70° C. and 93° C.) deposited coating, the advantageous characteristics thereof are primarily the uniform layer thickness distribution, high hardness, and wear resistance. Autocatalytically deposited nickel coatings grow uniformly during the coating, in contrast to galvanic deposition, everywhere that the component is wet and the electrolyte exchange necessary for growing the layer takes place.

The chemically reductive process takes place at temperatures between 70° and 93° C. and in pH ranges from 4.2 to 6.5.

The deposition includes the following in percents by weight:

| | | | |
|---|---|---|---|
| Nickel | 65-98% | preferably | 85-90% |
| Phosphorus | 1-15% | preferably | 8-10% |
| PTFE | 1-20% | preferably | 2-5% |

PTFE is polytetrafluoroethylene and is an unbranched, linear, partially crystalline polymer made of fluorine and carbon. This plastic is also commonly referred to by the trade name “Teflon” from DuPont. This material has superb sliding characteristics, which are also guaranteed during dry running. Significantly lower wear values could be demonstrated for elements of the eccentric drive with a chemical nickel layer with phosphorus and solid particles of PTFE, in comparison to other coatings, by which means the wear resistances and thus the operating temperatures in the inventive device could be reduced.

Further inclusions provided, which are deposited with embodiments of the invention, are: additional hardening components, like silicon carbide 0.1-20%, or boron carbide 0.1-20%, or diamond 0.1-20%. These types of layers are especially wear-resistant.

The corrosion resistance of these layers is very good. They are also resistant to alkaline solutions, weak acids, seawater, lubricants, fuels, and solvents. The resistance against lubricants is especially advantageous for the use as slide coatings of the invention, since eccentric drives usually run lubricated. A further advantage of these coatings is that they have a high surface strength in the thermally post-treated state. The hardness values on the surface after tempering at 190° C. at a dwell time of approximately 4 hours lies in the range from 500 to 600 HV 0.1. With a thermal treatment during tempering below 200° C., the connection between the metal surface of the element and the coating is additionally stabilized at the surface section, i.e. the holding ability of the layer on the metal surface is improved.

Further embodiments of the invention provide that the layer has at least on one surface of one of the elements a composition in the range of at least 65 to 90% by weight of nickel, 1 to 15% phosphorus, and 1 to 20% particles of a solid lubricant, the layer has at least on one surface of one of the elements a composition in the range of at most 85 to 90% by weight of nickel, 8 to 10% phosphorus, and 2 to 5% particles of a solid lubricant, and the layer has a surface is hardness of 500 to 550 HV 0.1.

Table 3 shows an overview of the characteristics preferably for the layers used for the embodiments of the invention and the important process variables/parameters for the production thereof.

TABLE 3

| | Process variable: | |
|---|---|---|
| | Value/characteristic | Value/characteristic |
| | deposited quickly | deposited slowly |
| Ni (g/l) | 5.5 or 6.0 | 6.0 or 7.0 |
| pH range at pH | 4.0-5.5 | 4.5-5.5 |
| adjustment using NH3, | | |
| carbonate, hydroxide | | |
| T (° C.) | 80-95 | |
| Process speed layer thickness | 20 +/− 5 | 10 +/− 1 |
| MTO | >7 | >5. |
| Phosphorus content % | 5-9 | 10-13 |
| | magnetic | non-magnetic |
| Hardness (0.1 HV) | 600 +/− 50 | 500 +/− 50 |
| | Corrosion resistance | Corrosion resistance |
| | good | very good |

The information regarding hardness HV relates to a known method for measuring the Vickers hardness, which is used for hardness testing of thin-walled workpieces and edge zones, and is generally regulated according to DIN EN ISO 6507-1:2005 to −4:2005.

MTO stands for the term “metal turn over,” which stands for the conversion of the electrolytes after a certain throughput of supplemental chemicals, after which the electrolytes must be recharged and the equipment must be cleaned.

In order to achieve phosphorus contents above 10%, a deposition speed of preferably lower than 12 μm/hr is provided.

### BRIEF DESCRIPTION OF THE DRAWINGS

The present invention will be explained in greater detail below on the basis of preferred exemplary embodiments in connection with the associated figures.

The figures show the following:

FIG. 1 is a side view of a device designed as a planetary drive;

FIG. 2 is a section view of a device designed as a planetary drive shown along line II-II of FIG. 1;

FIG. 3 is a perspective view of a planetary bearing;

FIG. 4 is a section view of a bearing cage shown along the rotational axis;

FIG. 5 is a section view of a bearing cage shown along the rotational axis; and,

FIG. 6 is a vertical section view of a surface section.

### DETAILED DESCRIPTION

At the outset, it should be appreciated that like drawing numbers on different drawing views identify identical, or functionally similar, structural elements of the invention. It is to be understood that the disclosure as claimed is not limited to the disclosed aspects.

Furthermore, it is understood that the claims are not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this invention belongs. It should be understood that any methods, devices or materials similar or equivalent to those described herein can be used in the practice or testing of the invention.

The invention is subsequently explained in more detail by way of an embodiment.

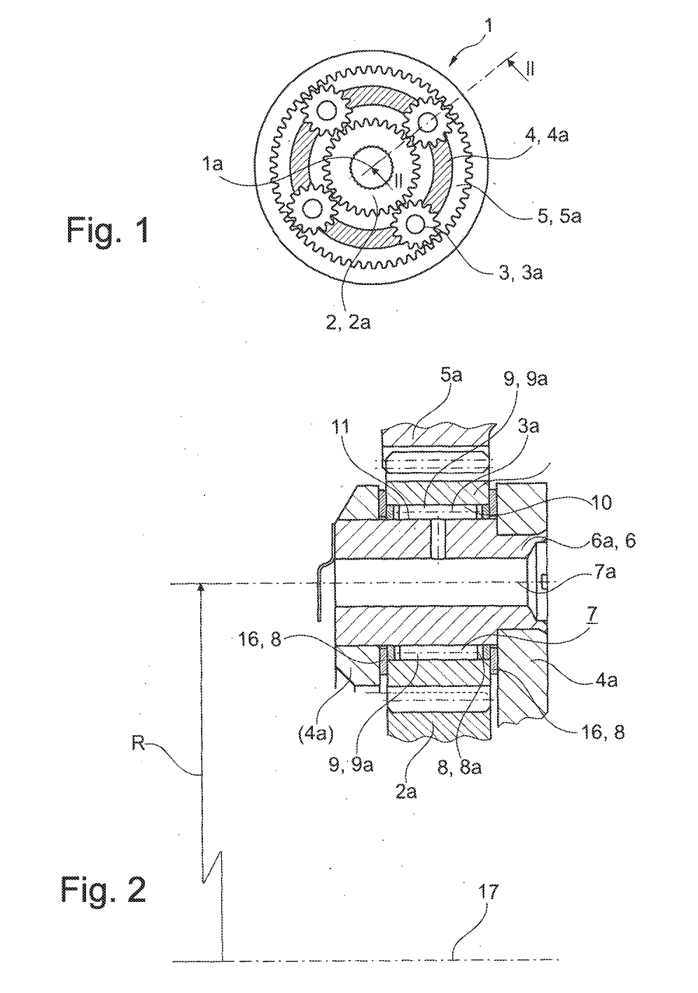

FIG. 1 shows, in a side view and not to scale, a device 1 designed as a planetary drive 1a with elements 2, 3, 4, and 5 that can be moved relative to one another. Element 2 is a sun gear 2a, elements 3 (first elements 3) are planetary gears 3a that engage with sun gear 2a. Element 5 is an annulus gear 5a, with which planetary gears 3a engage. Element 4 (third element 4) is a planet carrier 4a.

FIG. 2 shows a detail of the device in a section along line II-II of FIG. 1. For each planetary gear 3a, a further element 6 (second element 6), which is designed as planetary bolt 6a, is fixed to planet carrier 4a. Each planetary gear 3a is rotatably mounted around rotational axis 7a on planetary bolt 6a (on the second element 6) by means of a roller bearing 7. Each of planetary gears 3a engages with annular gear 5a and with sun gear 2a. Rotational axis 7a. is spaced at a radius R from central axis 17 of planetary drive 1a.

Roller bearing 7 has elements 8 and 9, inner race 10 and outer race 11. Element 8 (fourth element 8) is a cage 8a, and elements 9 are rollers 9a. A further fourth element 8, realized respectively as a thrust washer 16, is arranged on planetary bolt 6a axially between each of planetary gears 3a and a section of the planet carrier 4a. Elements 2, 3, 4, 5, 6, 8, and 16 are optionally all, or only one, or a few of the same, coated on at least one surface section with the inventive layer in the ratio V indicated.

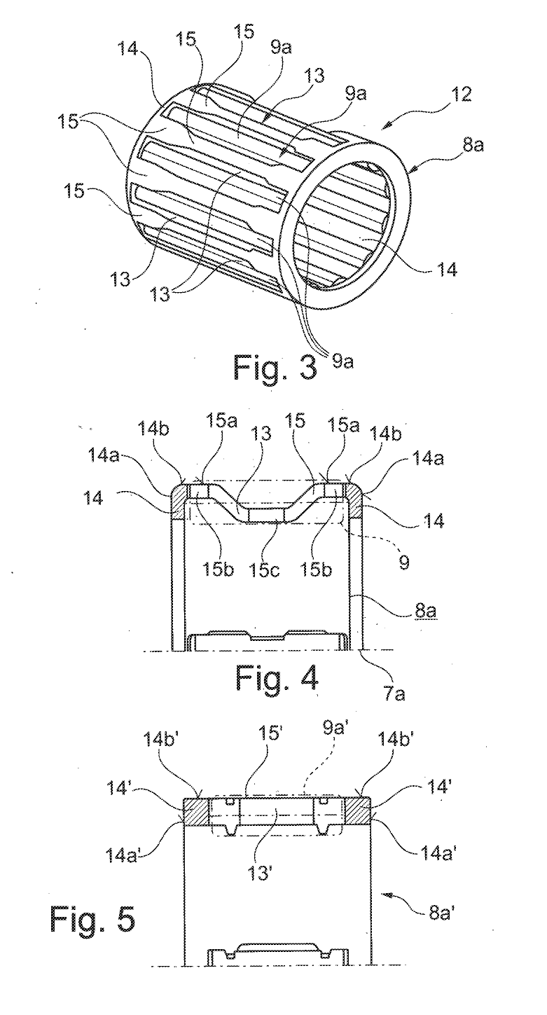

FIG. 3 shows an example of a planetary bearing 12 in a complete view. Planetary bearing 12 is formed by cage 8a and rollers 9a. Rollers 9a are received in pockets 13 of cage 8a uniformly distributed in the peripheral direction. Cage 8a is formed from lateral edges 14, which are transversely (axially) connected to one another by cross bars 15.

FIG. 4 shows cage 8a split in half in a longitudinal cut along rotational axis 7a. Cage 8a has therein a so-called M-profile, which is characterized by the radially oriented rectangular profile of lateral edges 14 and by the depressed center of cross bar 15 depicted in the longitudinal cut. Lateral edges 14 have respectively on the face ends an axially outward facing surface 14a and on the outer peripheral side an outer cylindrical surface 14b. Two radially outwardly directed surface sections 15a are designed on cross bars 15, which sections lie in a common cylindrical curved surface with outer cylindrical surfaces 14b and which respectively transition into one of outer cylindrical surfaces 14b. Cross bars 15 additionally also have so-called mountings, on which surface sections 15b and 15c facing respective roller 9a in pocket 13 are designed. The invention is also provided for roller bearings that have more than one row of rollers, and thus also more than one row of pockets in one cage or in more than one adjacently arranged cages.

FIG. 5 shows an alternative embodiment of a planetary bearing with a cage 8a′ (fourth element), in which rollers 9a′ are distributively received. Cage 8a′ has lateral edges 14′, which are axially connected to one another by cross bars 15′. Cage 8a′ is represented split in half in a longitudinal cut along rotational axis 7a and has in the representation a profile, which is characterized by the quadratic transverse section of lateral edges 14′ and by cross bar 15′ designed like a beam. Lateral edges 14′ respectively have a face side surface 14a′ with an annular shape on the face side directed axially outward and an outer cylindrical surface 14b′ outside on the peripheral side. Two radially outwardly directed surface sections 15a′ are designed on cross bars 15′, which sections lie in a common cylindrical curved surface with outer cylindrical surfaces 14b′ and which respectively transition into one of outer cylindrical surfaces 14b′. Cross bars 15′ additionally also have so-called supports, on which surface sections 15b′ and 15c′ facing respective roller 9a′ in pocket 13′ are designed.

Cages 8a, 8a′ are either completely coated, or coated on surface sections 14a, 14a′, 15a, 15a′, 15b, 15b′, and 15c, or 15c′ either completely or partially with the inventive layer in the ratio V provided.

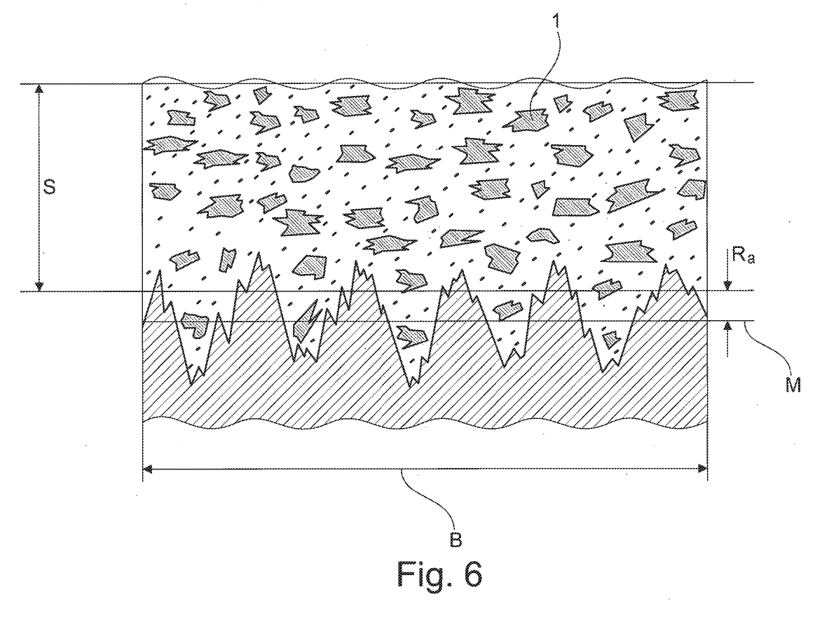

FIG. 6 shows a vertical cut through the surface of a surface section coated with the inventive layer of the layer thickness S, either on a cage, a thrust washer, or a planet carrier along the set reference length B, in which particles 18 made of PTFE are distributed.

1-12. (canceled)

13. A device comprising:
a plurality of elements arranged to move relative to each other, wherein the plurality of elements comprises:
at least one first element of the plurality of elements on an at least one bearing point;
a second element, wherein the at least one bearing point is rotatably or pivotably mounted on the second element;
a third element arranged to be rotatable around a central axis of the device, wherein the second element is mounted on the third element at a radial distance from the central axis of the device;
a fourth element, wherein the fourth element is integral to the at least one bearing point and is at least temporarily in sliding contact with another of the plurality of elements in at least one sliding contact zone, which sliding contact zone is arranged to have at least one surface section having at least one layer comprising:
a nickel-phosphate alloy; and,
at least one solid lubricant distributed in the at least one layer, wherein a ratio of a surface roughness of a rough metal surface of the at least one surface section to a thickness of the at least one layer of the at least one layer is in a range of at least 0.0008 to 3.0.

14. The device of claim 13, wherein the at least one layer adheres to the rough metal surface of the at least one surface section, and the ratio is in the range of at most 0.005 to 1.2.

15. The device of claim 13, further comprising:
at least one roller bearing in the at least one bearing point arranged to mount the at least one first element on the second element and having at least one row of rollers arranged on a peripheral side of the surface section around the second element and at least the fourth element.

16. The device of claim 13, wherein the fourth element comprises at least one cage in which rollers are guided.

17. The device of claim 13, further comprising:
at least one thrust washer arranged on a mounting point, wherein the first element or the fourth element move axially along the thrust washer.

18. The device of claim 13, further comprising:
at least one thrust washer arranged on a mounting point, wherein the thrust washer is the fourth element and the first element moves axially along the thrust washer.

19. The device of claim 13, wherein the at least one first element comprises a planetary gear arranged to be rotatably mounted on the second element, the second element comprises a planetary bolt fixedly secured to the third element, and the third element comprises a planetary carrier arranged to be rotatable around the central axis of the device.

20. The device of claim 13, wherein the layer thickness extending from the rough metal surface of the at least one surface section is in a range of 0.5 to 100 μm.

21. The device of claim 13, wherein the at least one solid lubricant is PTFE.

22. The device of claim 13 wherein the at least one layer on the at least one surface section comprises a composition comprising at least 65% to 90% nickel by weight, 1% to 15% phosphorus by weight, and 1% to 20% particles made of the solid lubricant by weight.

23. The device of claim 13 wherein the at least one layer on the at least one surface section comprises a composition comprising at most 85% to 90% nickel by weight, 8% to 10% phosphorus by weight, and 2% to 5% particles made of the solid lubricant by weight.

24. The device of claim 13 wherein the at least one layer on the at least one surface section has a surface hardness of 500 to 550 HV.
